(19) United States
(12) Patent Application Publication
(10) Pub. No.: US 2013/0264406 A1
(43) Pub. Date: Oct. 10, 2013

(54) MEDIA STIRRER MILL AND METHOD OF PREPARING DISPERSION ELEMENT

(71) Applicants: Hiroki Morioka, Shizuoka (JP); Shigeo Hatada, Shizuoka (JP); Masahiro Kawamoto, Shizuoka (JP)

(72) Inventors: Hiroki Morioka, Shizuoka (JP); Shigeo Hatada, Shizuoka (JP); Masahiro Kawamoto, Shizuoka (JP)

(73) Assignee: RICOH COMPANY, LTD., Tokyo (JP)

(21) Appl. No.: 13/855,028

(22) Filed: Apr. 2, 2013

(30) Foreign Application Priority Data
Apr. 6, 2012 (JP) 2012-087788

(51) Int. Cl. B02C 23/00

(52) U.S. Cl. CPC B02C 23/00
USPC 241/278.1

(57) ABSTRACT

A media stirrer mill, including a dispersion container; a stirring member rotatable in the dispersion container; and a dispersion chamber formed in a gap between the stirring member and the dispersion container, including a dispersion media configured to disperse a material, wherein the dispersion container includes concavities having arc-like bottoms and convexities on its inner wall surface.

### CROSS-REFERENCE TO RELATED APPLICATIONS

This patent application is based on and claims priority pursuant to 35 U.S.C. §119 to Japanese Patent Application No. 2012-087788, filed on Apr. 6, 2012, in the Japan Patent Office, the entire disclosure of which is hereby incorporated by reference herein.

### BACKGROUND OF THE INVENTION

1. Field of the Invention

The present invention relates to a media stirrer mill and a dispersion method using the media stirrer mill.

2. Description of the Related Art

Demands from the market for higher image resolution have been increasing in electronic printing and electrophotographic fields recently.

In order to improve image resolution of images or letters printed on papers by electronic devices such as copiers and printers, not only toners and inks for inkjet used for printing but also photoreceptors in the copiers and the printers need higher functionality.

For that purpose, each constituent material indispensably needs atomizing and being dispersed with a uniform particle diameter. Conventionally, media stirrer mills dispersing the constituent materials with dispersion media are widely used as dispersers for atomization.

As a conventional media stirrer mill, Japanese Patent No. JP-3830194-B1 (Japanese published unexamined application No. JP-H09-225279-A) discloses a media stirrer mill having a stirring disc including at least 5 notch channels on an outer circumference of the disc, extending from an inside of an outer circumferential circle of the disc to the downstream in a rotational direction of the disc to have an opening on the outer circumference of the disc, and plural media passing through-holes inside in a radius direction from the notch channels, in which the number of the notch channels is from 1/15 to 1/25 of an outer diameter [mm] of the disc (integer, after the decimal point of which is cut off), and when the maximum calculation result is 4 or less, the number thereof is determined as 5. The stirring disc prevents media from being eccentrically located and assures sufficient momentum of the media to perform a desired process without deterioration of dispersion capability.

Japanese published unexamined application No. JP-2007-275832-A discloses a media stirrer mill including plural openings for circulating first media at an equal interval in a circumferential direction on a cylindrical wall of a stirring member, and plural openings for circulating second and third media at an equal interval in a circumferential direction on outer edges of a hub and a closed plate of the stirring member, respectively, in which the closed plate makes an outer edge of the stirring member bilaterally symmetric. The stirring member improves dispersion efficiency without segregation of media and with active behavior thereof.

Japanese published unexamined application No. JP-H08-10635-A discloses a media stirrer mill including a cylindrical dispersion chamber and a stirring shaft located along an axial line of the dispersion chamber, rotating around the axial line, in which plural fixed stirrer elements fixed on an inner wall of the dispersion chamber, the inner edge of which reaches near a side surface of the stirring shaft and plural rotational stirrer elements fixed on the side surface of the stirring shaft, the outer edge of which reaches the inner wall of the dispersion chamber are alternately located in a direction of the axial line. The media stirrer mill disclosed therein including the fixed stirrer elements on the inner wall of the dispersion chamber besides the stirring member can apply large shearing force over the whole area of the dispersion chamber to raise the level of atomization.

Japanese published unexamined application No. JP-2003-71262-A discloses a media stirrer mill including a stirring member located in a cylindrical dispersion chamber and formed of a plate blade having a predetermined length in a direction of the axial line of the dispersion chamber, in which a plate fin having a predetermined length in a direction of the axial line is located projecting in an inner circumferential direction of the dispersion chamber on an inner wall surface thereof located on an outer circumference of the location of the blade so as not to contact the blade. The media stirrer mill disclosed therein including the blade as a stirring member and the fin on the inner wall surface of the dispersion chamber can apply a uniform shearing force at any location in the dispersion chamber to disperse without unevenness and has high dispersion capability, applying a very large shearing force.

The dispersers disclosed in Japanese Patent No. JP-3830194-B1 (Japanese published unexamined application No. JP-H09-225279-A) and Japanese published unexamined application No. JP-2007-275832-A shape their stirring members to improve dispersion capability and efficiency, assuring momentum of the dispersion media and circulating the dispersion media without eccentric location and segregation thereof. However, they have room for improvement in terms of uniformity of the particle diameter distribution of a material to be dispersed.

The disperser disclosed in Japanese published unexamined application No. JP-H08-10635-A including the fixed stirrer elements on the inner wall of the dispersion chamber besides the stirring member can apply large shearing force over the whole area of the dispersion chamber to raise the level of atomization, but has room for improvement in terms of uniformity of the particle diameter distribution of a material to be dispersed, which is not considered.

The disperser disclosed in Japanese published unexamined application No. JP-2003-71262-A including the blade as a stirring member and the fin on the inner wall surface of the dispersion chamber can uniformly stir the dispersion media and increase the shearing force raised thereby to perform efficient and uniform dispersion. However, the effect is not sufficient and there is room for improvement.

Because of these reasons, a need exist for a media stirrer mill atomizing constituent materials for a toner for electrophotography and an inks for inkjet, in which dispersion media are uniformly present in each dispersion space without being eccentrically located in a dispersion chamber.

### SUMMARY OF THE INVENTION

Accordingly, one object of the present invention to provide a media stirrer mill atomizing constituent materials for a toner for electrophotography and an inks for inkjet, in which dispersion media are uniformly present in each dispersion space without being eccentrically located in a dispersion chamber.

Another object of the present invention to provide a method of preparing a dispersed material using the media stirrer mill.

A further object of the present invention to provide a dispersed material using the media stirrer mill.

Another object of the present invention to provide a dispersed pigment using the media stirrer mill.

These objects and other objects of the present invention, either individually or collectively, have been satisfied by the discovery of a media stirrer mill, comprising:

a dispersion container;

a stirring member rotatable in the dispersion container; and

a dispersion chamber formed in a gap between the stirring member and the dispersion container, comprising a dispersion media configured to disperse a material,

wherein the dispersion container comprises concavities having arc-like bottoms and convexities on its inner wall surface.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a schematic view illustrating an embodiment of the media stirrer mill of the present invention;

FIG. 2 is a cross-section view of a part indicated by an arrow A in FIG. 1;

FIG. 3 is a schematic view illustrating concavities and convexities on an inner wall surface of a dispersion container and movement of dispersion media near a stirring blade as a stirring member in FIG. 2;

FIG. 4 is a schematic view illustrating a media stirrer mill of the present embodiment used in Example;

FIG. 5 is a schematic view illustrating another media stirrer mill of the present embodiment used in Example;

FIG. 6 is a schematic view illustrating a further media stirrer mill of the present embodiment used in Example;

FIG. 7 is a schematic view illustrating a conventional media stirrer mill used in Comparative Example;

FIG. 8 is a schematic view illustrating a media stirrer mill used in Comparative Example;

FIG. 9 is a schematic view illustrating another media stirrer mill used in Comparative Example;

FIG. 10 is a diagram showing a transitional total number of coarse particles relative to power consumption/slurry amount;

FIG. 11 is a diagram showing a particle diameter distribution of a dispersed material in Example; and

FIG. 12 is a schematic view illustrating another embodiment of the media stirrer mill of the present embodiment.

### DETAILED DESCRIPTION OF THE INVENTION

The present invention provides a media stirrer mill atomizing constituent materials for a toner for electrophotography and an inks for inkjet, in which dispersion media are not only uniformly present in each dispersion space without being eccentrically located in a dispersion chamber, but also applied with sufficient motion energy to improve dispersion efficiency and obtain a dispersed material having a uniform particle diameter.

More particularly, the present invention relates to a media stirrer mill, comprising:

a dispersion container;

a stirring member rotatable in the dispersion container; and

a dispersion chamber formed in a gap between the stirring member and the dispersion container, comprising a dispersion media configured to disperse a material,

wherein the dispersion container comprises concavities having arc-like bottoms and convexities on its inner wall surface.

Exemplary embodiments of the present invention are described in detail below with reference to accompanying drawings. In describing exemplary embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

Hereinafter, an embodiment having an axial line of a shaft in a horizontal direction is explained. An explanation of an embodiment having an axial line of a shaft in a vertical direction is omitted, but the present invention can be applied thereto.

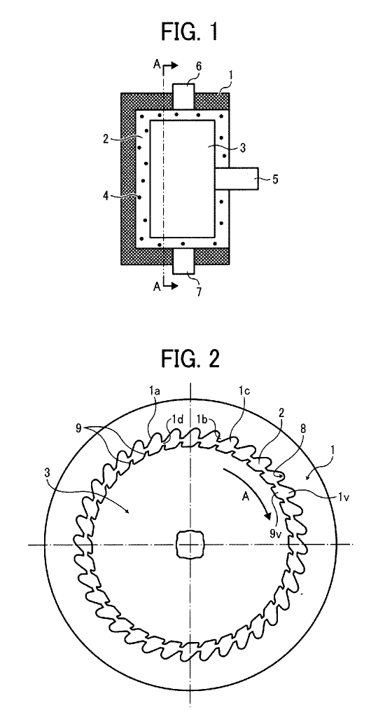

FIG. 1 is a schematic view illustrating an embodiment of the media stirrer mill of the present invention.

A dispersion container and a stirring member of Dinomill KDL-A from SHINMARU ENTERPRISES CORPORATION are replaced by those of the present invention to prepare the media stirrer mill, which includes a dispersion container 1, a stirring member 3 rotatable therein, a dispersion chamber 2 formed in a gap therebetween and dispersion media 4, and rotates the stirring member 3 in the dispersion chamber 2 to atomize an object to be dispersed (not illustrated) with the dispersion media 4.

The dispersion mechanism of the media stirrer mill is explained.

A raw materials is fed with the dispersion media in the dispersion chamber formed in a gap between the dispersion container and the stiffing member in therein, and moved with the dispersion media while receiving rotational force of the stirring member in the dispersion chamber. The object to be dispersed receives dispersion force such as colliding force and shearing force from the movement of the dispersion media therebetween to be atomized.

In order to increase dispersion efficiency and obtain a dispersed material having a uniform particle diameter, all the objects to be dispersed need to receive high and uniform collision force and shearing force. Namely, the dispersion media need to have high motion energy and uniform concentration.

The dispersion container 1 has a concave and convex inner wall surface 1a formed of a concavity 1b and a convexity 1c shown in FIG. 2. As FIG. 2 shows, the concavity and convexity preferably has an arc-like bottom surface 8, and further the arc-like bottom surface 8 is preferably inclined in an upstream direction along a rotational direction of the stirring member 3. The arc-like bottom surface 8 can form a flow efficiently returning the dispersion media 4 thrown out by a centrifugal force by rotation of the stirring member 3 to outer circumference of the dispersion chamber 2 in a direction of the center. Therefore, the dispersion media 4 has a constant concentration in the dispersion chamber 2, and uniform shearing force can be applied to the object to be dispersed and a dispersed material having a uniform particle diameter can be obtained.

The stirring member 3 preferably has a stirring blade 9 as shown in FIG. 2. The dispersion media 4 having entered between the stirring blades 9 rotate therewith by rotation of the stirring member 3 to efficiently apply dispersion force to the object to be dispersed.

A capacity 9v between the stirring blades 9 extending inclined along an upstream side of the rotational direction on an outer circumference of the stirring member is preferably smaller than a capacity 1v of the convexity 1c on the inner wall surface of the dispersion container. The dispersion media 4 is applied with motion energy by rotation of the stirring member 3 between the stirring blades 9, and is likely to be thrown out by a centrifugal force by rotation of the stirring member 3 to outer circumference of the dispersion chamber 2 at the same time. The dispersion media tend to have low concentration between the stirring blades 9 and is difficult to have uniform concentration in the dispersion chamber 2.

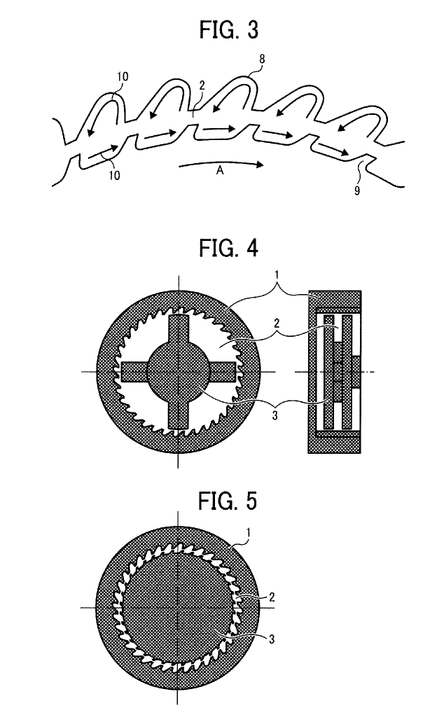

FIG. 3 is a schematic view illustrating the concavities and convexities on the inner wall surface of the dispersion container and movement of the dispersion media near the stirring blade as the stirring member. Thus, the dispersion media having a uniform concentration while applied with sufficient motion energy has high dispersion efficiency and can obtain a dispersed material having a uniform particle diameter.

Conventional media stirrer mills change its stirring member or its inner wall surface of the dispersion container to improve dispersion efficiency and move the dispersion media in the dispersion chamber without being eccentrically located to improve uniformity of the dispersion concentration, the effect of which is still insufficient.

However, the media stirrer mill of the present invention can form a flow efficiently returning the dispersion media thrown out to the outer circumference of the dispersion chamber due to a centrifugal force by rotation of the stirring member in a direction of the center while applying sufficient motion energy to the dispersion media. The dispersion media have a uniform concentration in the dispersion chamber, and the dispersion efficiency is high and a dispersed material having a uniform particle diameter can be obtained.

The shape and the number of the concavities and convexities on the inner wall surface of the dispersion container and those of the stirring blade may be determined according to the object to be dispersed and the dispersion media used. In many case, the numbers thereof are preferably same in consideration of balance of flow of the dispersion media in the dispersion chamber.

When the number of the concavities and convexities on the inner wall surface of the dispersion container and that of the stirring blade are same, the flow returning the dispersion media in a direction of the center and a flow of throwing the dispersion media to the outer circumference of the dispersion chamber due to a centrifugal force by rotation of the stirring member are well balanced, the dispersion media have a uniform concentration in the dispersion chamber and a dispersed material having a uniform particle diameter can be obtained.

### EXAMPLES

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

The following materials were mixed to prepare a slurry (a) used for evaluation.

Colorant: Yellow pigment: 3%

Dispersant: 1.1%

Distilled water: 95.9%

In Example 1, the media stirrer mill in FIGS. 1 and 4, including a dispersion container including concavities having arc-like bottoms and convexities on its inner wall surface was used.

In Example 2, the media stirrer mill in FIGS. 1 and 5, including a dispersion container including concavities having arc-like bottoms and convexities on its inner wall surface, and a stirring member including a stirring blade was used.

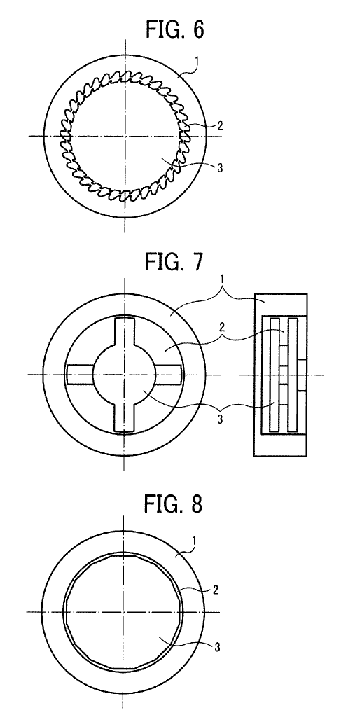

In Example 3, the media stirrer mill in FIGS. 1 and 6, including a dispersion container including concavities having arc-like bottoms and convexities on its inner wall surface, a stirring member including a stirring blade, and in which a capacity between the stirring blades is smaller than that of the concavity on the inner wall surface of the dispersion container was used.

In Comparative Example 1, the conventional media stirrer mill in FIG. 7 was used.

In Comparative Example 2, the conventional media stirrer mill in FIG. 8 was used.

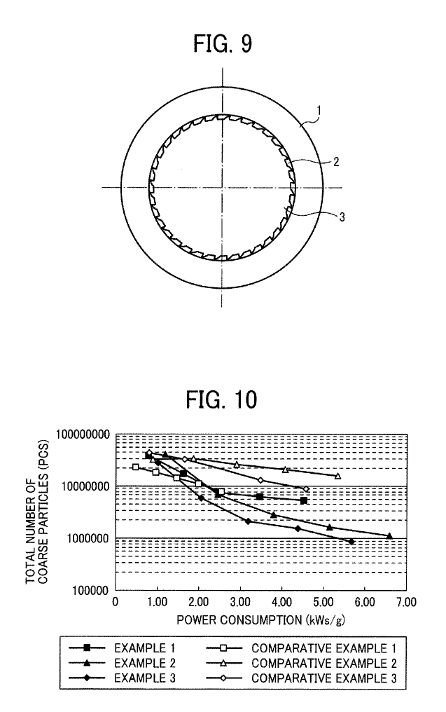

In Comparative Example 3, the conventional media stirrer mill in FIG. 9 including the stirring member including the stirring blade of the present invention was used. Minimum clearances between all of the dispersion containers and the stirring members were 2 mm.

### Example 1

The slurry (a) was dispersed in the media stirrer mill in FIGS. 1 and 4, including a dispersion container including concavities having arc-like bottoms and convexities on its inner wall surface using zirconia beads having a diameter of 0.05 mm at a filling rate of 80%, a peripheral speed of 10 m/s and dispersion times of 90, 180, 270, 360 and 450 sec to prepare a pigment dispersion element.

### Example 2

The procedure for preparation of the pigment dispersion element in Example was repeated except for using the media stirrer mill in FIGS. 1 and 5, including a dispersion container including concavities having arc-like bottoms and convexities on its inner wall surface, and a stirring member including a stirring blade.

### Example 3

The procedure for preparation of the pigment dispersion element in Example was repeated except for using the media stirrer mill in FIGS. 1 and 6, including a dispersion container including concavities having arc-like bottoms and convexities on its inner wall surface, a stirring member including a stirring blade, and in which a capacity between the stirring blades is smaller than that of the concavity on the inner wall surface of the dispersion container.

### Comparative Example 1

The procedure for preparation of the pigment dispersion element in Example 1 was repeated except for using the conventional media stirrer mill in FIG. 7 (without concavities and convexities on the inner wall surface of the dispersion container).

### Comparative Example 2

The procedure for preparation of the pigment dispersion element in Example 1 was repeated except for using the conventional media stirrer mill in FIG. 8 (without concavities having arc-like bottoms and convexities on its inner wall surface, and a stirring member including a stirring blade).

### Comparative Example 3

The procedure for preparation of the pigment dispersion element in Example 1 was repeated except for using the conventional media stirrer mill in FIG. 9, including only the stirring member including the stirring blade.

Next, the number of coarse particles of the pigment dispersion element having a particle diameter not less than 0.5 μm was measured by a particle diameter distribution measurer Accusizer 780 from Particle Sizing Systems.

Effective capacities in Examples and Comparative Examples are different from each other, and the total number of coarse particles relative to power consumption/slurry amount in each Example and Comparative Example was measured for fair evaluation. The results are shown in FIG. 10.

The number of coarse particles in Example 1 decreases faster than Comparative Example 1 under the same dispersion conditions, which proves Example 1 has higher dispersion efficiency.

It is assumed that the concavities and convexities on the inner wall surface of the dispersion container in Example 1 can form a flow efficiently returning the dispersion media thrown out by a centrifugal force by rotation of the stirring member to outer circumference of the dispersion chamber in a direction of the center to promote atomization.

Comparative Example 1 is slow in decreasing coarse particles and has poor dispersion efficiency. It is thought this is because the dispersion media is eccentrically located at the outer circumference of the dispersion chamber due to a centrifugal force by rotation of the stirring member, and motion energy is not efficiently applied to the dispersion media and an object to be dispersed is not promoted.

The number of coarse particles in Example 2 decreases faster than Comparative Example 2, which proves Example 2 has higher dispersion efficiency.

It is assumed that the stirring blade of the stirring member in Example 2 applies sufficient motion energy to the dispersion media and efficiently applies dispersion energy to an object to be dispersed to promote atomization.

Comparative Example 2 is slow in decreasing coarse particles and has poor dispersion efficiency. It is thought this is because the stirring member does not have the stirring blade, and sufficient motion energy is not applied to the dispersion media to promote atomization.

The number of coarse particles in Example 3 decreases faster than Comparative Example 3, which proves Example 3 has higher dispersion efficiency.

It is assumed that the concavities and convexities on the inner wall surface of the dispersion container in Example 3 can form a flow efficiently returning the dispersion media thrown out by a centrifugal force by rotation of the stirring member to outer circumference of the dispersion chamber in a direction of the center to promote atomization.

Comparative Example 3 is slow in decreasing coarse particles and has poor dispersion efficiency. It is thought this is because the dispersion media is eccentrically located at the outer circumference of the dispersion chamber due to a centrifugal force by rotation of the stirring member, and motion energy is not efficiently applied to the dispersion media and an object to be dispersed is not promoted.

The number of coarse particles in Example 2 decreases faster than Example 1, which proves Example 2 has higher dispersion efficiency.

It is assumed that the stirring blade of the stirring member in Example 2 applies sufficient motion energy to the dispersion media and efficiently applies dispersion energy to an object to be dispersed to promote atomization.

It is thought that Example 1 is not designed to apply sufficient motion energy to the dispersion media and the atomization is less promoted than Example 2.

The number of coarse particles in Example 3 decreases faster than Example 2, which proves Example 3 has higher dispersion efficiency.

It is assumed that in Example 3, since a capacity between the stirring blades is smaller than that of the concavity on the inner wall surface of the dispersion container, the dispersion media in the dispersion chamber can have a uniform concentration while applied with sufficient motion energy, and that the atomization is more efficiently promoted than Example 2.

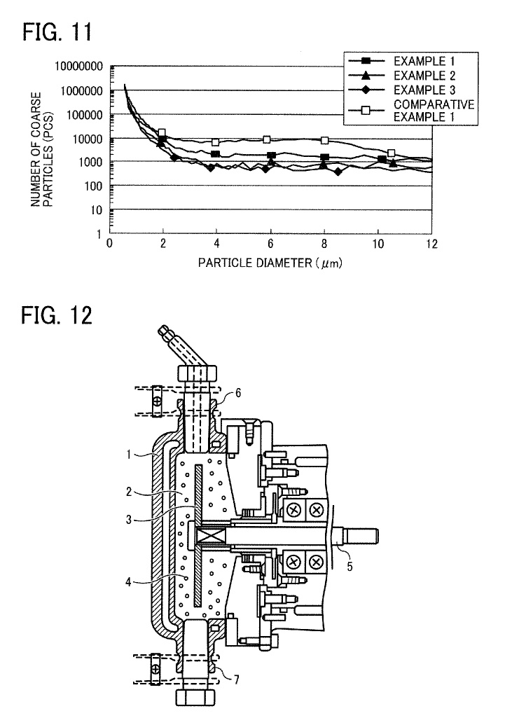

Next, the particle diameter distributions of Examples 1 to 3 and Comparative Example 1, measured by AccuSizer 780 from Particle Sizing Systems are shown in FIG. 11. ▪, ▴, ♦ and □ are to separate diagrams from each other and the number thereof have nothing to do with the number of measured points. Sixty (60) points were actually measured. An average particle diameter, a standard deviation and a variation coefficient (standard deviation/average particle diameter) are shown in Table 1. In order to execute a fair evaluation even when the dispersion statuses are largely different from each other, the comparisons were made when dispersion times at which the total numbers of coarse particles are close to each other, i.e., Example 1: 360 sec; Example 2: 180 sec; Example 3: 180 sec; and Comparative Example 1: 45 sec. Comparative Examples 2 and 3 were not compared because the dispersion statues were largely different from each other.

TABLE 1

| | Average | Standard | Variation |
|---|---|---|---|
| | Particle Diameter | Deviation | Coefficient |
| | [APD] (μm) | [SD] (μm) | (SD/APD) |
| Example 1 | 0.71 | 0.54 | 0.76 |
| Example 2 | 0.63 | 0.41 | 0.65 |
| Example 3 | 0.64 | 0.37 | 0.58 |
| Comparative | 0.81 | 0.97 | 1.20 |
| Example 1 | | | |

From FIG. 11 and Table 1, Examples 1 to 3 are proved to have smaller variation coefficients than Comparative Example 1 under the same dispersion conditions and produce dispersed materials having uniform particle diameters.

Particularly, Example 3 can form a flow efficiently returning the dispersion media thrown out by a centrifugal force by rotation of the stirring member to outer circumference of the dispersion chamber in a direction of the center with the concavities and convexities on the inner wall surface of the dispersion chamber. In addition, since a concave capacity of the stirring member is smaller than that on the inner wall surface of the dispersion container, the dispersion media in the dispersion chamber has a uniform concentration to apply a uniform shearing force to an object to be dispersed, and a dispersed material having a uniform particle diameter can be obtained.

The media stirrer mill of the present invention has higher dispersion capability and efficiency, and can produce a dispersed material having more uniform particle diameter than conventional media stirrer mills.

Having now fully described the invention, it will be apparent to one of ordinary skill in the art that many changes and modifications can be made thereto without departing from the spirit and scope of the invention as set forth therein.

What is claimed is:

1. A media stirrer mill, comprising:
a dispersion container;
a stirring member rotatable in the dispersion container; and
a dispersion chamber formed in a gap between the stirring member and the dispersion container, comprising a dispersion media configured to disperse a material,
wherein the dispersion container comprises concavities having arc-like bottoms and convexities on its inner wall surface.

2. The media stirrer mill of claim 1, wherein the stirring member comprises a stirring blade.

3. The media stirrer mill of claim 2, wherein a capacity between the stirring blades is smaller than that of the concavity on the inner wall surface of the dispersion container.
